(19) United States
(12) Patent Application Publication
(10) Pub. No.: US 2016/0059967 A1
(43) Pub. Date: Mar. 3, 2016

(54) USE OF ICE-PHOBIC COATINGS

(71) Applicant: ESTUARY HOLDING B.V., Bussum (NL)

(72) Inventors: Cornelis Antonie TJEENK WILLINK, Den Haag (NL); Eric Daniel TIERIE, Bilthoven (NL); David Jan Jacob ENTHOVEN, Bussum (NL)

(73) Assignee: Estuary Holding B.V., Bussum (NL)

(21) Appl. No.: 14/778,960

(22) PCT Filed: Mar. 24, 2014
(86) PCT No.: PCT/NL2014/050180

§ 371 Date: Sep. 21, 2015

(30) Foreign Application Priority Data
Mar. 22, 2013 (NL) 2010504

(51) Int. Cl. B64D 15/00; C09K 3/18; F03D 11/00; F03D 1/06; F03D 9/00

(52) U.S. Cl. CPC B64D 15/00; F03D 1/0675; F03D 9/002; F03D 11/0025; C09K 3/18

(57) ABSTRACT

The invention pertains to the use of an ice-phobic coating layer for de-icing or anti-icing of technical aerospace equipment such as aircraft's carburettor(s), pitot tubes, engines and parts thereof, and the rotor blades and generators and parts thereof of wind turbines, and wherein said coating layer: a) exhibits sessile water drop contact angle of at least 75° and a difference in dynamic water drop contact angle of at most 30° , more preferably at most 25° (i.e. low wetting hysteresis), at ambient air conditions, said contact angles measured according to ASTM D7334-08; b) exhibits micro hardness of at least 200 HV (Vickers units) if exposed to fluid velocities lower than 50 m/s and/or micro hardness of at least 800 HV, preferably at least 1000 HV, if exposed to fluid velocities higher than 100 m/s (representing aircraft wing conditions), said micro hardness measured according to ASTM E384-08, and/or exhibits a micro hardness of Ra less than 0.5 μm; c) exhibits corrosion rate of less than 0.1 μm/year; d) is chemically inert; and e) has a mechanical strength in terms of pull-off force/surface unit of more than 10 MPa, preferably more than 20 MPa, measured according to ASTM D4541-09e1.

### FIELD OF THE INVENTION

In one aspect, the invention rests in the field of ice formation on technical aerospace equipment that is exposed to cold air with a high relative humidity, particularly aerospace applications such as aircraft engines, pitot tubes and carburettors, and in one aspect also to the rotor blades and generators of wind turbines, and the like.

### BACKGROUND OF THE INVENTION

Atmospheric icing occurs amongst other circumstances on aerospace equipment, such as aircraft when flying through under-cooled water or when a very cold aircraft descends into lower air layers with a high relative humidity, but also on equipment exposed to wind containing under-cooled water such as wind turbines . As the aircraft flies, including take-off and landing, it causes the portion of the air that it encounters to move around it rapidly. Water droplets, either resident in that air or through condensation on a cold surface, cannot move rapidly enough, due to their mass, to avoid the aircraft and instead strike or impinge the parts of the aircraft making contact. The same applies for rotor blades of static wind-turbines that are exposed to wind velocities. When such water droplets are under-cooled, they change phases to solid when they strike or impinge these aircraft parts or wind turbine rotor blades. Ice therefore forms on the leading or forward-facing edges of the wings, tail, antennas, windshield, radome, engine inlet, propellers and so forth.

Ice formation on an aircraft may seriously affect its aerodynamics and even the weight, which results in degraded performance and control. It disadvantageously affects aerodynamic performance; aircraft control can be seriously affected by ice accretion, potentially resulting in a stall and/or roll upset. WO 2004/078873 discloses hard, ice-phobic coatings which can be applied to air foil surfaces to reduce ice adhesion on airfoil surfaces which are surfaces designed to produce reaction forces from the air through which it moves. It deals with ice formation on aircraft wings and propellor leading edges and surfaces which are moving through air, in order to stimulate the aerodynamics of these surfaces such as lift and forward movement of aircraft.

However, the art does not address the issues of ice formation on other parts of the aircraft, those that will do not move through air in order to generate forces as described in WO 2004/078873. When ice that has formed on an engine intake manifold or cowling fractures and breaks free, it can enter the engine and cause catastrophic mechanical damage. Pitot tubes either alone or combined with a static port, use pressure differences to measure crucial data such as air speed. To avoid freezing of a pitot tube, it is typically equipped with electrical heating activated either automatically or by a manual switch. Larger aircraft often are equipped with in-flight ice protection systems to reduce the effect of ice. Ice protection systems are classified as de-ice or anti-ice systems. These often involve heat or freezing-point depressants. Neither is attractive, consuming large amounts of aircraft power or chemicals such as ethylene- or propylene glycol. Still in 2009, ice formation in pitot tubes most likely caused the fatal jet crash of AF447.

Ice formation is also imminent in single engine aircrafts with piston-type engine in the carburettor for the fuel-air mixture supply. The evaporation of the fuel extracts warmth from the flow of the fuel-air mixture thus increasing the risk of ice formation. During descent, especially landing, at low rotations per minute and when the outside temperature is close to the dew point—and especially under higher relative moisture conditions—ice formation may cause blocking of the fuel—air mixture inlet flow through ice formation which leads to starvation of the engine resulting in the loss of propulsion again potentially resulting in a forced landing, irrespective of the suitability of the land or water underneath the aircraft, often with substantial damage and sometimes with fatal results.

The rotor blades of wind turbines can also be subjected to growth of ice on the leading edge of the blades when rain is sub-cooled—below freezing point temperatures—or in operation in low hanging clouds at low temperatures or in high moisture conditions with the rotor blades being below freezing point or cooled down by high velocities at the blade tips, and ice formation occurs. Unlike propellers which are driven by an engine to provide reactive forces thus moving the aircraft forward, rotor blades are driven by the wind on static wind turbines thus providing an active force driving a generator. This ice formation growth can have two effects: (1) due to high centrifugal forces caused by rotation of the blades the ice may shear off being a safety hazard for the environment (especially when installed near roadways, housing or other civilised area's), and (2) the growth of ice may cause instability and or imbalance of the blades which ultimately may even cause structural damage to the bearings or even the loss of a blade and disintegration of the wind turbine. For that reason wind turbines are often shut down when these environmental circumstances occur.

In the art there is a need for reducing or even avoiding formation of ice on the technical equipment of aircrafts such as engines, pitot tubes and carburettors and other technical parts of the aircraft which are subject to low temperature and high moisture conditions. In the art there is also a need for reducing or even avoiding formation of ice on the rotor blades and generators of wind turbines. It is an object of the invention to provide a ready-to-apply, low-maintenance, energy-saving and economical improved way to reduce or even prevent ice-growth to engines, and the like.

### SUMMARY OF THE INVENTION

It is now found by the inventors that these objects can be achieved by applying an ice-phobic or ice-repellent coating to the in- and exterior parts of the aircraft pitot tube(s) and static ports in contact with the outside air and/or to the interior parts of the carburettor that is in contact with the hydrocarbon/air mixture flow. In one aspect, the invention also pertains to the use of such ice-phobic coating to the rotor blades and generators of wind turbines. These have all surfaces at risk of ice formation but have little to do with the production of reaction forces from the air in order to realize movement, and the ice formation induced aerodynamic issues associated therewith.

The above coating will make it hard for under-cooled water and ice-like structures to attach and subsequently grow. The repellent and ice-phobic coating will be more economical than more traditional thermal protection discussed in the background section. The anti-ice coatings render the use of heaters, redesigned engine positioning and freezing-point depressants redundant. In a preferred embodiment the coating layer is applied either directly or as a multi-layered film comprising of a base layer; the ice-phobic coating layer provided on a top surface of the base layer; an adhesive layer provided on a bottom surface of the base layer.

Airfoil surfaces that (are designed to) produce reaction forces from the air through which these surfaces move such as wings, leading edges of propellers and aircraft fuselages are preferably excluded from the surfaces targeted in the context of the invention. In a preferred embodiment, the invention pertains to non-aerodynamic technical aerospace equipment and appliances.

The “ice-phobic” or “ice-repellent” properties of the coating are such that the coating layer prevents under-cooled water and solidified ice and ice-like structures from attaching and growing on to the above exposed surfaces. The coating layer has to satisfy a number of conditions: 1) it provides a low adhesion strength between the coating surface and the water droplets, or for that matter, provides at least a high contact angle with the liquid phase from which the ice is formed and shows low wetting hysteresis; 2) it exhibits sufficient high micro-hardness, preferably at least equal to the hardness of the base material; 3) it shows little or no corrosion/erosion in time; 4) it is chemically inert (including resistance to de-icing fluids), in particular to the materials it makes contact with, and 5) the bonding of the coating to the underlying material—such as aluminium, or other metals/alloys, or composite base material—has sufficient mechanical strength.

In a preferred embodiment, the coating layer of the invention comprises diamond like carbon (DLC) comprising fractions of one or more components selected from the group consisting of silicon (Si), oxygen (O) and fluor (F).

### LIST OF EMBODIMENTS

1. Use of an ice-phobic coating layer for de-icing or anti-icing technical aerospace equipment such as an aircraft's carburettor(s), pitot tubes, engines and parts thereof, and the rotor blades and generators and parts thereof of wind turbines, and wherein said coating layer:
a) exhibits sessile water drop contact angle of at least 75° and a difference in dynamic water drop contact angle of at most 30°, more preferably at most 25° (i.e. low wetting hysteresis), at ambient air conditions, said contact angles measured according to ASTM D7334-08 ;
b) exhibits micro hardness of at least 200 HV (Vickers units) if exposed to fluid velocities lower than 50 m/s and/or micro hardness of at least 800 HV, preferably at least 1000 HV, if exposed to fluid velocities higher than 100 m/s (representing aircraft wing conditions), said micro hardness measured according to ASTM E384-08, and/or exhibits a micro hardness of Ra less than 0.5 μm;
c) exhibits corrosion rate of less than 0.1 μm/year;
d) is chemically inert; and
e) has a mechanical strength in terms of pull-off force/surface unit of more than 10 MPa, preferably more than 20 MPa, measured according to ASTM D4541-09e1.

2. A method for reducing or preventing under-cooled and solidified water condensables, ice and ice-like structures to adhere, form and/or grow on technical aerospace equipment such as an aircraft's carburettor(s), pitot tubes, engines and parts thereof, and the rotor blades and generators and parts thereof of wind turbines, by applying a ice-phobic coating layer which:
a) exhibits sessile water drop contact angle of at least 75° and a difference in dynamic water drop contact angle of at most 30°, more preferably at most 25° (i.e. low wetting hysteresis), at ambient air conditions, said contact angles measured according to ASTM D7334-08 ;
b) exhibits micro hardness of at least 200 HV (Vickers units) if exposed to fluid velocities lower than 50 m/s and/or micro hardness of at least 800 HV, preferably at least 1000 HV, if exposed to fluid velocities higher than 100 m/s (representing aircraft wing conditions), said micro hardness measured according to ASTM E384-08, and/or exhibits a micro hardness of Ra less than 0.5 μm;
c) exhibits corrosion rate of less than 0.1 μm/year;
d) is chemically inert; and
e) has a mechanical strength in terms of pull-off force/surface unit of more than 10 MPa, preferably more than 20 MPa, measured according to ASTM D4541-09e1.

3. Use or method according to any one of the preceding embodiments, wherein said coating layer comprises diamond like carbon (DLC) comprising fractions of one or more components selected from the group consisting of silicon (Si), oxygen (O) and fluor (F).

4. Use or method according to embodiment 1 or 2, wherein said coating layer comprises ceramic materials containing metal nitrides and/or carbides.

5. Use or method according to any one of the preceding embodiments, wherein said coating layer is provided to the aircraft engine, the aircraft pitot tube(s), static ports, and other technical equipment in contact with the outside air and/or the interior parts of the carburettor that is in contact with the hydrocarbon/air mixture flow.

6. Use or method according to any one of the preceding embodiments, wherein said coating layer exhibits an adhesion reduction factor (ARF) of at least 1.5, preferably at least 3.

7. Use or method according to any one of the preceding embodiments, in which said coated surface has a Surface Skewness of more than 2 and Surface Kurtosis more than 20, preferably determined according to ISO/DIS 25178-2 and/or ASME B46.1.

8. Use or method according to any one of the preceding embodiments, wherein said coating layer has a Poisson's ratio equal to or larger than 0.4.

9. Use or method according to any one of the preceding embodiments, wherein said coating layer is applied as a multilayered film comprising a base layer; the ice-phobic coating layer provided on a top surface of the base layer; an adhesive layer provided on a bottom surface of the base layer.

### DETAILED DESCRIPTION OF THE INVENTION

In one aspect, the invention thus pertains to the use of an ice-phobic coating layer for de-icing or anti-icing, i.e. to reduce or even prevent under-cooled and solidified water condensables, ice and ice-like structures to adhere, form and/or grow either in or on technical equipment such as an aircraft's carburettor(s), pitot tubes, engines and parts thereof, and the rotor blades and generators and parts thereof of wind turbines, and wherein said coating layer:
a) exhibits sessile water drop contact angle of at least 75° and a difference in dynamic water drop contact angle of at most 30°, more preferably at most 25 ° (i.e. low wetting hysteresis), at ambient air conditions, said contact angles measured according to ASTM D7334-08 ;
b) exhibits micro hardness of at least 200 HV (Vickers units) if exposed to fluid velocities lower than 50 m/s and/or micro hardness of at least 800 HV, preferably at least 1000 HV, if exposed to fluid velocities higher than 100 m/s (representing aircraft wing conditions), said micro hardness measured according to ASTM E384-08, and/or exhibits a micro hardness of Ra less than 0.5 μm;
c) exhibits corrosion rate of less than 0.1 μm/year;
d) is chemically inert; and
e) has a mechanical strength in terms of pull-off force/surface unit of more than 10 MPa, preferably more than 20 MPa, said pull-off force measured according to ASTM D4541-09e1.

The ice-phobic coating layer is provided to the surface that is subject to ice formation. In the context of the invention, the terms ‘technical equipment of aerospace’ and ‘technical aerospace equipment’ are used interchangeably. Throughout the specification, the targeted surfaces are technical appliances in aerospace applications, preferably aircraft's carburettor(s), pitot tubes, engines and parts thereof, and preferably intended for avoiding malfunction—due to such ice formation—of these technical parts. In a preferred embodiment, the coating is not applied for improving aerodynamics of a surface moving through the air. In an embodiment, the coating is applied to technical non-aerodynamic aerospace surfaces, ie. those technical aerospace surfaces which are not (directly) providing lift or propulsion forces leading to movement.

In one embodiment of the invention, the micro hardness of the coating layer is preferably expressed in terms of Vicker units.

In one aspect of the invention, the coating has a high adhesion reduction factor (ARF), which is defined as F_alu/F_coating, wherein F_alu corresponds to the force required to shear off the ice mass from an uncoated aluminium surface, as a reference. The values for F_alu and F_coating can be readily derived from a Centrifugal Adhesion Test (CAT). Details of such a test are given in the examples. Clearly adhesion to other surfaces than aluminium are part of the invention and the ARF characterization does not imply that such other materials should be excluded, which are likely to be metals including alloys or composites with polymers, with or without fillers.

The ARF value is indicative for the desired ice adhesion prohibiting properties of the coating. The ARF should be at least 1.5, more preferably at least 2, even more preferably at least 3. These ARF values correspond to a ‘hysteresis’—difference between the advancing and receding contact angle in atmospheric conditions—of at most 30°, preferably at most 25°, more preferably at most 15°. These ARF values may form a suitable alternative characterization for the above dynamic contact angle measurements. Thus, in one embodiment, the coating may be characterized by (a): exhibiting sessile water drop contact angle as defined previously, and an ARF value of at least 1.5, more preferably at least 2, even more preferably at least 3.

It was found that coating materials with a relative high Poisson's ratio decrease the adhesion strength between the water condensables, ice and ice-like structures and the coating layer increase the ARF. Poisson's ratio is the ratio of transverse contraction strain to longitudinal extension strain in the direction of stretching force. Tensile deformation is considered positive and compressive deformation is considered negative. The definition of Poisson's ratio contains a minus sign so that normal materials have a positive ratio. In order to obtain the desired ARF values mentioned above, the preferred coating has a Poisson's ratio of at least 0.3, preferably at least 0.4, more preferably larger than 0.45.

Additionally or alternatively, the invention also pertains to a method for de-icing or anti-icing, i.e. to reduce or even prevent under-cooled and solidified water condensables, ice and ice-like structures to adhere, form and/or grow on technical aerospace equipment such as an aircraft's carburettor(s), pitot tubes, engines and parts thereof, and the rotor blades and generators and parts thereof of wind turbines by applying a coating layer such as defined. The terminology “reduce or prevent to adhere” is understood to mean lowering of the adhesion force acting between the solidified water condensables [ice] and the surface of the device exposed to said condensables.

The skilled person has no problem identifying which exterior surfaces or surface parts of the technical equipment of aerospace (preferably aircraft) and wind turbines are vulnerable to ice formation, and which are desired to keep free of unwanted ice formations in order to permit a device or material of which that surface forms part to perform its normal function. The surfaces or surface parts subject to ice formation preferably comprise the aircraft engine, the aircraft pitot tube(s) and static ports in contact with the outside air and/or the interior parts of the carburettor that is in contact with the hydrocarbon/air mixture flow; and the rotor blades and generators of wind-turbines. The surfaces or surface parts subject to ice formation preferably exclude the surface parts of aerospace applications such as aircraft which serve aerodynamic purposes and are designed to produce reaction forces in order to get and keep the aircraft moving.

### Contact Angle

The coating layer needs to provide for low adhesion between the coating surface and the surface of a water condensable. This is reflected in the term “ice-phobic” or “ice repellant” coating. This functional behaviour may readily be determined by the skilled person using routine water contact angle experiments at ambient air conditions, specified in e.g. ASTM D7334-08. A high water contact angle exhibits a small surface contact area per unit water volume, hence a relative low adhesion force per unit ice formed from the water phase.

It is essential that the coating provides for a static sessile water drop coating layer-water contact angle in air higher than 75°, preferably higher than 80°, most preferably even higher than 85° in combination with a difference in dynamic water drop contact angle of at most 30°, more preferably at most 25° (i.e. low wetting hysteresis). The present invention provides for straightforward contact angle measurements at ambient air conditions which stand model for the less defined conditions implied when in use, and thus make a perfect tool to determine the suitability of materials for the purpose of the invention. With “ambient air” conditions it is understood a relative humidity in the range of 20-60% RH, at a temperature in the range of 20-25° C., and atmospheric pressure.

It is preferred that the coating shows low wetting hysteresis (or high ARF), which can be derived from dynamic contact angle measurements, using the same conditions as taught for the static sessile drop contact angle measurements above. ‘Hysteresis’ corresponds to the difference between the advancing and receding angle. The advancing angle is the largest contact angle possible without increasing its solid/liquid interfacial area by adding volume dynamically. Correspondingly, the receding angle stands for the smallest possible angle when reducing volume._Hence, simple sessile drop measurements serve as an alternative to the Centrifugal Adhesion Test. It was found the above desired ARF values correspond to a difference between the advancing and receding contact angle in atmospheric conditions at most 30 degrees, preferably at most 25 degrees, preferably at most 20 degrees, particularly at most 15 degrees.

It is preferred that the coating maintains the above properties when exposed to a temperature in the range of −80 to +80° C., preferably in the range of −120 to +120° C.; and/or pH ranging from 2 to 10.

### Hardness

Further, the coating layer needs to exhibit sufficiently high wear resistance, i.e. high micro hardness. The coating preferably has a micro-hardness that is at least equal to the hardness of the base material to which the coating is applied. In accordance with the present invention, the coating layer should preferably have a micro hardness of at least 200 HV (Vickers units), more preferably at least 300 HV, most preferably at least 400 HV, if exposed to low air velocities typically lower than 50 m/s (as in carburettors). Additionally or alternatively, the coating layer has a micro hardness preferably higher than 800 HV, more preferably higher than 1000 HV if exposed to high fluid velocities, typically higher than 100 m/s, such as experienced on aircrafts that fly up to 250 m/s (civil) or even 750 m/s (military aircraft). These hardness values can be measured according to ASTM E384-08.

Most plastic and/or resin-based coatings do not satisfy the minimum required hardness of more than 200 HV.

In order to limit the effect of the coating on aerodynamics, it is preferred that the coated surface—additionally or alternatively—has a micro roughness of Ra less than 0.5 μm, more preferably 0.1-0.5 μm. These numbers may be achieved using micro blasting, preferably using aluminium oxide particles, preferably having a diameter of less than 50 micron. In one embodiment, it is preferred that the surface roughness of the coating (and underlying surface) is less than 0.05 micrometer, more preferably less than 0.02 micron, in all directions.

The properties of the peaks and troughs of the substrate of the coating also have an effect on the ice-phobic behaviour of a coating. Best results are achieved by providing the substrate with a nano-surface-structure characterised by a Surface Skewness>2 and Surface Kurtosis>20. This Skewness is a measure of the average of the first derivative of the surface (the departure of the surface from symmetry); Kurtosis is a measure of sharpness of profile peaks. These parameters can be readily determined using metrology standard ISO/DIS 25178-2 and/or ASME B46.1.

Corrosion resistance

In order to keep maintenance costs low and safeguard ice adhesion reduction over longer periods, the coating needs to show little or no corrosion in time. The rate of corrosion should be less than 0.1 micrometer/year. This criterion may alternatively be expressed over other, shorter time periods. Alternatively, the coating layer may exhibit a corrosion rate less than 0.008 μm/month, or 0.0019 μm/week. The extent or rate of corrosion is preferably determined by salt spray corrosion tests according to ASTM B 117.

Chemically inert

The coating layer or the materials contained therein are chemically inert to the fluids making contact with it, particularly inert to jet fuels, hydraulic fluids, and de-icing fluids and freezing-point depressants presently applied in the aircraft industry. In the field, these are referred to as aircraft de-icing/anti-icing fluids. The coating is preferably inert to ethylene glycol (EG) or propylene glycol (PG) which are typically used in such fluids. In addition, the coating is preferably chemically inert to alkanes, alkenes, alkynes, aromatic hydrocarbons, halogenated hydrocarbons, alcohols, carbon dioxide, hydrogen sulphide, mercaptans, and combinations thereof.

Mechanical strength

The coating has preferably a mechanical strength in terms of pull-off force/surface unit of more than 10 MPa, preferably more than 20 MPa, measured according to ASTM D4541-09e1. It is important that the coating adheres to the base material at the extreme conditions in which it is used.

Based on the preceding criterions the skilled person can readily select a suitable coating layer.

In one embodiment, the coating layer preferably comprises or is preferably formed from diamond-like carbon (DLC) comprising fractions of one or more components selected from the group consisting of silicon (Si), oxygen (O) and fluor (F), preferably a fluorinated diamond-like-carbon [F-DLC]; and/or an ceramic composition. The most preferred coating layer comprises DLC. In one embodiment, the coating layer of the invention contains predominant amounts, preferably more than 60 wt %, more preferably more than 80 wt %, most preferably more than 90 wt % of DLC. The weight-expressed numbers are based on the total weight of the coating layer. An example is DLN-360, commercially available with Bekaert (Belgium).

Other suitable coatings comprise one or more materials selected from the group consisting of metal alloys or metal carbides and/or nitrides. The metal in the metallic carbides and/or nitrides is preferably a transition metal of the group consisting of tungsten (wolfram), titanium, tantalum, molybdenum, zirconium, hafnium, vanadium, niobium, chromium, and combinations thereof. Preferred examples of metal nitrides are CrN, Cr₂N, ZrN, TiN, and preferred metal carbides comprise CrC, TiC, WC. Combinations are also included. The coating may also comprise mixtures of transition metal carbides and/or nitrides with Group VIII metals, such as iron, cobalt, nickel, as is taught in U.S. Pat. No. 5,746,803, its contents herein incorporated by reference. These coatings may be advantageously applied for de-icing or anti-icing technical equipment in aerospace, preferably an aircraft's carburettor(s), fuselage and/or flying surfaces and wind turbines, particularly for the aircraft's carburettor(s), pitot tubes, engines and parts thereof, and the rotor blades and generators and parts thereof of wind turbines; or in a method for reducing or preventing under-cooled and solidified water condensables, ice and ice-like structures to adhere, form and/or grow on aircraft's carburettor(s), fuselage and/or flying surfaces and wind turbines, particularly aircraft's carburettor(s), pitot tubes, engines and parts thereof, and the rotor blades and generators and parts thereof of wind turbines.

The descriptions above are intended to be illustrative, not limiting. Thus, it will be apparent to one skilled in the art that modifications may be made to the invention as described without departing from the scope of the claims set out below.

### EXAMPLES

### Example 1

### Coating Layer

The surface of a metal test part was coated with a 3 micrometer thick layer containing >90% w/w DLC, commercially available as DLN-360 (origin: Bekaert, Belgium under the brand name Dylyn®-DLC).

The following properties of said DLN 360 coating were determined using known techniques:
Water contact angle: 87° (sessile drop) [ASTM D7334-08; ambient conditions]
Hardness: 3000 HV [ASTM E384-08]
Corrosion rate: <0.1 μm/yr [ASTM B 117]
Ice adhesion strength: 0.233 MPa (+/−8%)
Adhesion reduction ARF: 2 (compared to bare aluminium surface)

The ice adhesion strength was determined in a test method called: Centrifugal Adhesion Test (CAT). Thereto, an impeller was coated at one impeller tip with the DLC coating over a surface of 1152 mm². The coated surface was cooled down to −5° C., where after a water ice-like layer built up by depositing a water fog on to the coated surface, resulting in an ice thickness of typically 8 mm over said surface of 1152 mm². The impeller was balanced by a counter weight mounted on the other impeller tip.

The impeller was then mounted on a shaft in a centrifuge chamber which was conditioned at −10° C. and at atmospheric pressure. On the outer wall of the centrifuge accelerometers were mounted which could detect the impact of an object colliding to said centrifuge wall. The rotational speed of the impeller was gradually increased with about 270 rpm/sec up to the point that ice-like mass detached from the impeller tip. The point in time at which the ice-like mass released from the tip surface was detected almost instantly by the accelerometers attached at the centrifuge wall. When the pulsed signal of the accelerometer was detected, the actual rpm value of the impeller was fixed. From 1) final fixed rpm value, 2) the radial distance between the mass centre point of ice and axis of rotation, 3) the ice mass and 4) the air shear force, the critical shear between ice and coating surface at which detachment occurs, was determined. The latter is referred to as ice adhesion strength (F). The adhesion reduction factor (ARF) is defined as F_alu/F_coating, wherein F_alu corresponds to the force required to shear off the ice mass from the uncoated aluminium surface. The ARF value is indicative for the desired ice adhesion prohibiting properties of the coating.

1.-9. (canceled)

10. A method for de-icing or anti-icing technical aerospace equipment, comprising applying to the aerospace equipment an ice-phobic coating layer comprising diamond like carbon (DLC) comprising fractions of one or more components selected from the group consisting of silicon (Si), oxygen (O) and fluor (F), wherein the coating layer:
(a) exhibits sessile water drop contact angle of at least 75° and a difference in dynamic water drop contact angle of at most 30°, at ambient air conditions, the contact angles measured according to ASTM D7334-08;
(b) exhibits micro hardness of at least 200 HV (Vickers units) if exposed to fluid velocities lower than 50 m/s and/or micro hardness of at least 800 HV, if exposed to fluid velocities higher than 100 m/s, the micro hardness measured according to ASTM E384-08, and/or exhibits a micro hardness of Ra less than 0.5 mm;
(c) exhibits corrosion rate of less than 0.1 mm/year;
(d) is chemically inert; and
(e) has a mechanical strength in terms of pull-off force/surface unit of more than 10 MPa, measured according to ASTM D4541-09e1.

11. The method according to claim 10, wherein the aerospace equipment comprises aircraft carburettor(s), pitot tubes, engines, rotor blades, generators, wind turbines, and parts thereof.

12. The method according to claim 10, wherein the difference in dynamic water drop contact angle is at most 25°.

13. The method according to claim 10, wherein coating exhibits a micro hardness of at least 1000 HV if exposed to fluid velocities higher than 100 m/s.

14. The method according to claim 10, wherein the coating has a mechanical strength of more than 20 MPa.

15. The method according to claim 1, wherein the coating layer is provided to the in- and exterior parts of the aircraft engine, the aircraft pitot tube(s) and static ports in contact with the outside air and/or the interior parts of the carburettor that is in contact with the hydrocarbon/air mixture flow.

16. The method according to claim 10, wherein the coating layer exhibits an adhesion reduction factor (ARF) of at least 1.5.

17. The method according to claim 10, wherein the coating layer exhibits an ARF of at least 3.

18. The method according to claim 10, in which the coated surface has a Surface Skewness of more than 2 and Surface Kurtosis more than 20, determined according to ISO/DIS 25178-2 and/or ASME B46.1.

19. The method according to claim 10, wherein the coating layer has a Poisson's ratio equal to or larger than 0.4.

20. The method according to claim 10, wherein the coating layer is applied as a multi-layered film comprising a base layer; the ice-phobic coating layer provided on a top surface of the base layer; an adhesive layer provided on a bottom surface of the base layer.

21. A method for reducing or preventing under-cooled and solidified water condensables, ice and ice-like structures to adhere, form and/or grow on technical aerospace equipment, comprising applying an ice-phobic coating layer comprising diamond like carbon (DLC) comprising fractions of one or more components selected from the group consisting of silicon (Si), oxygen (O) and fluor (F), wherein the coating layer:
(a) exhibits sessile water drop contact angle of at least 75° and a difference in dynamic water drop contact angle of at most 30°, at ambient air conditions, the contact angles measured according to ASTM D7334-08;
(b) exhibits micro hardness of at least 200 HV (Vickers units) if exposed to fluid velocities lower than 50 m/s and/or micro hardness of at least 800 HV, if exposed to fluid velocities higher than 100 m/s, the micro hardness measured according to ASTM E384-08, and/or exhibits a micro hardness of Ra less than 0.5 mm;
(c) exhibits corrosion rate of less than 0.1 mm/year;
(d) is chemically inert; and
(e) has a mechanical strength in terms of pull-off force/surface unit of more than 10 MPa, measured according to ASTM D4541-09e1.

22. The method according to claim 21, wherein the aerospace equipment comprises aircraft carburettor(s), pitot tubes, engines, rotor blades, generators, wind turbines, and parts thereof.

23. The method according to claim 21, wherein the coating layer exhibits an adhesion reduction factor (ARF) of at least 1.5.

24. The method according to claim 21, in which the coated surface has a Surface Skewness of more than 2 and Surface Kurtosis more than 20, determined according to ISO/DIS 25178-2 and/or ASME B46.1.

25. The method according to claim 21, wherein the coating layer has a Poisson's ratio equal to or larger than 0.4.

26. A method of de-icing or anti-icing of technical aerospace equipment, comprising applying to the equipment a coating layer comprising ceramic materials containing metal nitrides and/or carbides, wherein the coating layer:
(a) exhibits sessile water drop contact angle of at least 75° and a difference in dynamic water drop contact angle of at most 30°, at ambient air conditions, the contact angles measured according to ASTM D7334-08;
(b) exhibits micro hardness of at least 200 HV (Vickers units) if exposed to fluid velocities lower than 50 m/s and/or micro hardness of at least 800 HV, if exposed to fluid velocities higher than 100 m/s, the micro hardness measured according to ASTM E384-08, and/or exhibits a micro hardness of Ra less than 0.5 mm;
(c) exhibits corrosion rate of less than 0.1 mm/year;
(d) is chemically inert; and
(e) has a mechanical strength in terms of pull-off force/surface unit of more than 10 MPa, measured according to ASTM D4541-09e1.

27. The method according to claim 26, wherein the technical aerospace equipment comprises aircraft carburettor(s), fuselage and/or flying surfaces, pilot tubes, engines and parts thereof; and wind turbines, rotor blades, generators and parts thereof

28. A method for reducing or preventing under-cooled and solidified water condensables, ice and ice-like structures to adhere, form and/or grow on technical aerospace equipment, comprising applying to the equipment a coating layer comprising ceramic materials containing metal nitrides and/or carbides, wherein the coating layer:
(a) exhibits sessile water drop contact angle of at least 75° and a difference in dynamic water drop contact angle of at most 30°, at ambient air conditions, the contact angles measured according to ASTM D7334-08;
(b) exhibits micro hardness of at least 200 HV (Vickers units) if exposed to fluid velocities lower than 50 m/s and/or micro hardness of at least 800 HV, if exposed to fluid velocities higher than 100 m/s, the micro hardness measured according to ASTM E384-08, and/or exhibits a micro hardness of Ra less than 0.5 mm;
(c) exhibits corrosion rate of less than 0.1 mm/year;
(d) is chemically inert; and
(e) has a mechanical strength in terms of pull-off force/surface unit of more than 10 MPa, measured according to ASTM D4541-09e1.

29. The method according to claim 28, wherein the technical aerospace equipment comprises aircraft carburettor(s), fuselage and/or flying surfaces, pilot tubes, engines and parts thereof; and wind turbines, rotor blades, generators and parts thereof.
